(19) United States
(12) Patent Application Publication
(10) Pub. No.: US 2020/0093072 A1
(43) Pub. Date: Mar. 26, 2020

(54) HORTICULTURAL LIGHTING APPARATUS

(71) Applicant: Nanoco Technologies Ltd., Manchester (GB)

(72) Inventors: Nigel Leroy Pickett, Manchester (GB); David Thomas Webb, Tameside (GB)

(21) Appl. No.: 16/571,689

(22) Filed: Sep. 16, 2019

Related U.S. Application Data
(60) Provisional application No. 62/736,193, filed on Sep. 25, 2018.

(51) Int. Cl. A01G 9/24; A01G 7/04; B82Y 20/00

(52) U.S. Cl. CPC A01G 9/249; F21Y 2115/10; B82Y 20/00; A01G 7/045

(57) ABSTRACT

A horticultural lighting apparatus includes a housing; a blue-light emitting element; an emissive layer in optical communication with the blue-light emitting element, the emissive layer includes a polymer material and a population of quantum dots dispersed within the polymer material capable of absorbing blue light and emitting light having wavelengths in the red and far-red regions of the electromagnetic spectrum; a brightness enhancing film in optical communication with the blue-light emitting element and emissive layer; and a protective cover layer. The protective cover layer and housing isolates the blue-light emitting element, emissive layer and brightness enhancing film from the external environment. Methods of growing plants include illuminating a plant with a horticultural lighting apparatus according the present disclosure.

### CROSS REFERENCE TO RELATED APPLICATION

This application claims the benefit of U.S. Provisional Application No. 62/736,193 filed Sep. 25, 2018, the entire contents of which are incorporated herein by reference.

### FIELD OF THE INVENTION

The present invention relates to lighting apparatuses for horticultural applications.

### BACKGROUND OF THE DISCLOSURE

### Semiconductor Nanomaterials

There has been substantial interest in the preparation and characterization of compound semiconductors consisting of particles with dimensions in the order of 2-100 nm, often referred to as quantum dots (QDs) and/or semiconductor nanoparticles. Studies in this field have focused mainly on the size-tunable electronic, optical and chemical properties of nanoparticles. Semiconductor nanoparticles are gaining interest due to their potential in commercial applications as diverse as biological labeling, solar cells, catalysis, biological imaging, and light-emitting diodes.

Two fundamental factors (both related to the size of the individual semiconductor nanoparticles) are primarily responsible for their unique properties. The first is the large surface-to-volume ratio: as a particle becomes smaller, the ratio of the number of surface atoms to those in the interior increases. This leads to the surface properties playing an important role in the overall properties of the material. The second factor is that, for many materials (including semiconductor nanoparticles), the electronic properties of the material change with particle size. Moreover, because of quantum confinement effects, the band gap typically becomes gradually larger as the size of the nanoparticle decreases. This effect is a consequence of the confinement of an “electron in a box,” giving rise to discrete energy levels similar to those observed in atoms and molecules, rather than a continuous band as observed in the corresponding bulk semiconductor material. Semiconductor nanoparticles tend to exhibit a narrow bandwidth emission that is dependent upon the particle size and composition of the nanoparticle material. The first excitonic transition (band gap) increases in energy with decreasing particle diameter.

Semiconductor nanoparticles of a single semiconductor material, referred to herein as “core nanoparticles,” along with an outer organic passivating layer, tend to have relatively low quantum efficiencies due to electron-hole recombination occurring at defects and dangling bonds situated on the nanoparticle surface that can lead to non-radiative electron-hole recombinations.

One method to eliminate defects and dangling bonds on the inorganic surface of the nanoparticle is to grow a second inorganic material (typically having a wider band-gap and small lattice mismatch to that of the core material) on the surface of the core particle to produce a “core-shell” particle. Core-shell particles separate carriers confined in the core from surface states that would otherwise act as non-radiative, recombination centers. One example is ZnS grown on the surface of CdSe cores. Another approach is to prepare a core-multishell structure where the “electron-hole” pair is completely confined to a single shell layer consisting of a few monolayers of a specific material such as a quantum dot-quantum well structure. Here, the core is typically a wide bandgap material, followed by a thin shell of narrower bandgap material, and capped with a further wide-bandgap layer. An example is CdS/HgS/CdS grown using substitution of Hg for Cd on the surface of the core nanocrystal to deposit just a few monolayers of HgS that is then overgrown by monolayers of CdS. The resulting structures exhibit clear confinement of photo-excited carriers in the HgS layer.

The most-studied and prepared semiconductor nanoparticles to date have been so-called “II-VI materials,” for example, ZnS, ZnSe, CdS, CdSe, and CdTe, as well as core-shell and core-multishell structures incorporating these materials. However, cadmium and other restricted heavy metals used in conventional QDs are highly toxic elements and are of major concern in commercial applications.

Other semiconductor nanoparticles that have generated considerable interest include nanoparticles incorporating Group III-V and Group IV-VI materials, such as GaN, GaP, GaAs, InP, and InAs. Due to their increased covalent nature, III-V and IV-VI highly crystalline semiconductor nanoparticles are more difficult to prepare and much longer annealing times are usually required. However, there are now reports of III-VI and IV-VI materials being prepared in a similar manner to that used for the II-VI materials.

### Horticultural Lighting

In recent years, there has been widespread interest in the development of light-emitting diodes (LEDs) for horticultural lighting applications. It is believed that LEDs can be used to enhance photosynthesis and trigger photomorphogenesis in growing plants. High pressure sodium (HPS) lamps were initially utilised for grow light applications, but have gradually being replaced by LED-based systems that can better replicate the absorption spectrum of key pigments within the plant, such as chlorophylls, and emit less heat, which can be damaging to the growing plants. There are many examples of commercially available LED grow lamps. A number of systems utilise a combination of blue- and red-emitting LEDs. Such lighting systems typically employ an array of red LEDs interspersed with blue LEDs to provide a desired blue-to-red photon ratio.

Sunlight provides wavelengths of energy between 280-2500 nm. Plants, however, use wavelengths of light between 400 and 700 nm to drive photosynthesis, which is the range called Photosynthetically Active Radiation (PAR). In the field of horticultural lighting, the amount of photosynthetically active radiation received by a plant and is often quoted as a figure of merit for the performance of a grow light and is typically quoted as the photosynthetic photon flux (PPF): the amount of light produced in the PAR range per second (measured in mol·s⁻¹), or the photosynthetic photon flux density (PPFD): the amount of PAR light that actually reaches a plant over a given area (measured in mol·s⁻¹ m⁻²). Though the exact desired ratio of blue to red light is still uncertain and may vary between different plant species, and the PPF and PPFD values relate to the quantity rather than the quality of the light output, it is generally reported that a high values are beneficial for plant growth. Other related figures of merit include, the photon efficiency (PE): the amount of energy used by a lighting fixture to provide PAR to a plant, and the daily light integral (DLI): the amount of PAR available to a plant in a day-period. However, it has been recognised that wavelengths outside of the PAR range may also be beneficial to plant growth, including UV (˜300-400 nm) and far-red (700-800 nm) light. The narrowband emission offered by LEDs is also recognised to be advantageous for horticultural lighting applications.

FIG. 1 is a schematic illustration of a horticulture lighting apparatus of the prior art. The horticulture lighting apparatus includes a plurality of individual red light-emitting and blue light-emitting light emitting diodes (LEDs) in a housing and isolated from the external environment via a transparent protective cover through which light emitted from LEDs can pass. FIG. 2 is an isometric image of a commercially available horticulture lighting apparatus (sometimes referred to as a luminaire) which includes a plurality of red, green and blue LEDs. FIG. 3 is an environmental view of commercially available horticulture lighting apparatuses in use, which includes a plurality of red and blue LEDs. Though these designs enable the ratio of different colours of light to be controlled by varying the amounts of red, green and blue LEDs, the colours of light are emitted from discrete locations within a luminaire, such as shown in FIGS. 1-3, which may lead to colour hotspots. Further, the emission from solid-state LED-based lighting systems is restricted by the availability of LEDs emitting at particular desired wavelengths.

Aside from LED-based horticultural lighting systems, metal halide lamps have been used to deliver light, both within and beyond the PAR range, to growing plants. However, the spectral properties of metal halide lamps are not ideally suited to horticultural lighting due to low coherence with pigment absorption, particularly in the red range, a high blue content, and the spectrum cannot be tuned. In addition, metal halide lamps contain toxic mercury and are easily breakable, presenting an environmental risk. The lifetime of metal halide lamps is lower than that of LEDs, while the lamps produce significantly more heat, which could be damaging to growing plants.

Other commercially available horticultural lighting systems, such as fluorescent lamps and high pressure sodium lamps, do not emit in the far-red range.

### BRIEF DESCRIPTION OF THE DRAWINGS

FIG. 1 is a schematic illustration of a horticulture lighting apparatus of the prior art;

FIG. 2 is an isometric image of a horticulture lighting apparatus of the prior art;

FIG. 3 is an environmental view of prior art horticulture lighting apparatuses in use;

FIG. 4 is a schematic illustration of a horticulture lighting apparatus in accordance with various aspects of the present disclosure;

FIG. 5 is a schematic illustration of another horticulture lighting apparatus in accordance with various aspects of the present disclosure;

FIG. 6 is an image of a partially assembled horticulture lighting apparatus, according to the schematic illustration of FIG. 5, in accordance with various aspects of the present disclosure;

FIG. 7 is a schematic illustration showing the distribution of light onto a grow shelf from a quantum dot-containing horticulture lighting apparatus (“QD Lamp”) without a brightness enhancing optical film (BEF) in accordance with FIG. 4 of the present disclosure;

FIG. 8 is a brightness enhancement map generated from the use of a QD Lamp without a BEF in accordance with FIG. 4 of the present disclosure;

FIG. 9 is a schematic illustration showing the distribution of light onto a grow shelf from a quantum dot-containing horticulture lighting apparatus (“QD Lamp”) having a brightness enhancing optical film (BEF) in accordance with FIG. 5 of the present disclosure;

FIG. 10 is a brightness enhancement map generated from the use of a QD Lamp with a BEF in accordance with FIG. 5 of the present disclosure;

FIG. 11 is a graph comparing the vertical emission pattern (photon count relative to horizontal measurement position) of a quantum dot-containing horticulture lighting apparatus without a BEF film (“QD Lamp w/o BEF”) in accordance with FIG. 4 of the present disclosure and a quantum dot-containing horticulture lighting apparatus having a BEF film (“QD Lamp w/BEF”) in accordance with FIG. 5 of the present disclosure; and

FIG. 12 is a graph comparing the spectral output of a commercially available horticulture lighting apparatus using having red and blue light emitting diodes (LEDs) and a quantum dot-containing horticulture lighting apparatus (“QD Lamp”) in accordance with FIG. 4 of the present disclosure.

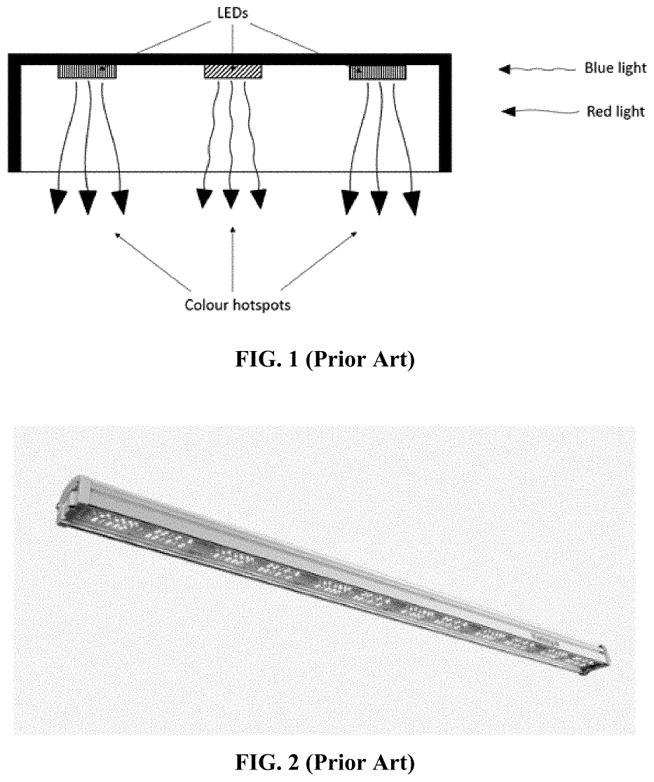

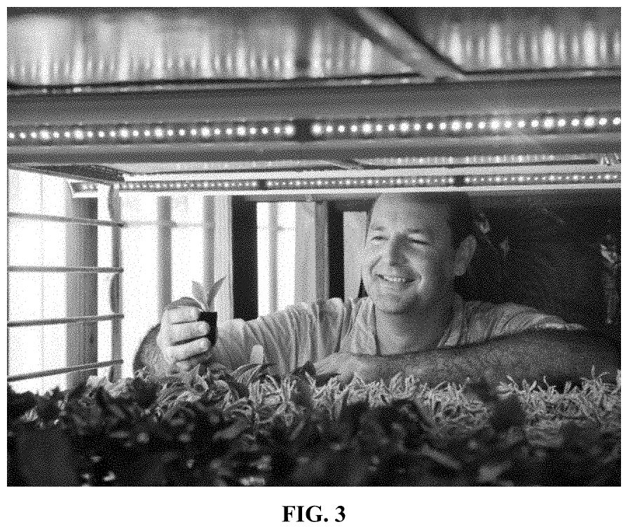

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, and alternatively ±1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

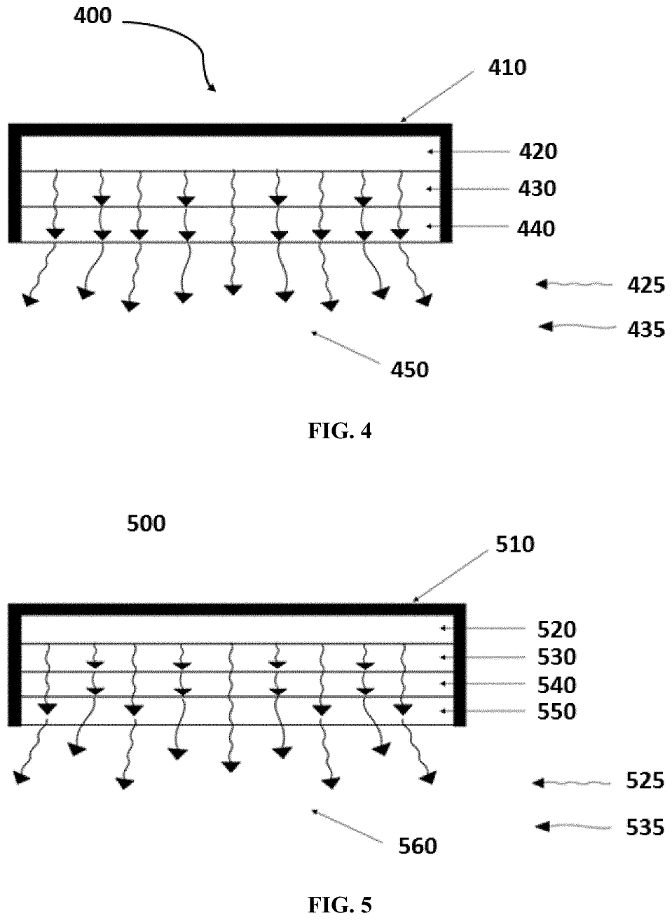

FIG. 4 is a schematic illustration of a horticulture lighting apparatus 400 in accordance with various aspects of the present disclosure. The horticulture lighting apparatus 400 includes a housing 410, an LED board 420 comprising a plurality of blue light-emitting LEDs (not shown), an emissive layer 430 comprising a plurality of quantum dots (not shown) capable of absorbing blue light from the plurality of blue light-emitting LEDs and emitting light having a wavelength within one or both of the red and far-red regions of the electromagnetic spectrum, and a protective cover layer 440. In combination, the housing 410 and the protective cover layer 440 at least physically isolate the LED board 420 and emissive layer 430 from the environment external to the horticulture lighting apparatus 400. In some instances, the housing 410 and the protective cover layer 440 can combine to form a hermetic seal to further isolate the LED board 420 and emissive layer 430 from the environment external to the horticulture lighting apparatus 400. In some instances, the blue light-emitting LEDs are InGaN-based LEDs. In some instances, the blue light-emitting LEDs emit blue light having a wavelength of about 450 nm.

In the horticulture lighting apparatus 400, blue light 425 is produced by the plurality of blue light-emitting LEDs of the LED board 420. The blue light 425 then travels to the emissive layer 430. In the emissive layer 430, a portion of the blue light 425 is absorbed by the plurality of quantum dots and converted to red and/or far-red light 435 while another portion of the blue light 425 is not absorbed by the plurality of quantum dots. The unabsorbed blue light 425 and the produced red/far-red light 435 then travel through the protective cover layer 440 as output light 450. In some instances, the emissive layer 430 can have a thickness ranging from about 200 to about 600 micrometers (m). In other instances, the emissive layer 430 can have a thickness ranging from about 250 to about 550 μm, alternatively from about 300 to about 525 μm, alternatively from about 350 to about 500 μm, alternatively from about 400 to about 480 μm, and alternatively from about 430 to about 470 μm. In some instances, the emissive layer 430 can have about 0.8 to about 2 grams of quantum dots per square meter of film area. In other instances, the emissive layer 430 can have about 1 to about 1.75 grams of quantum dots per square meter of film area. In yet other instances, the emissive layer 430 can have about 1.2 to about 1.5 grams of quantum dots per square meter of film area.

In some instances, reflective or scattering agents dispersed throughout the emissive layer 430 to assist in the scattering of light 425,435 within the film, promoting the production of a uniform spectral output, and/or increase the amount of light emitted from the emissive layer 430. In some instances, reflective or scattering agents can be made of, for example, polymer particles (for example, polytetrafluoro ethylene (PTFE) particles), metal particles, metal oxide nanoparticles (for example, titanium dioxide or zinc oxide), aluminium silicate particles, yttrium aluminium garnet (YAG) particles, barium sulfate particles, and glass particles.

In some instances, the protective cover layer 440 is transparent such that blue light 425 emitted from the plurality of blue light-emitting LEDs and the red/far-red light 435 emitted from the plurality of quantum dots pass directly therethrough such that the optical path of the light 425,435 is substantially unchanged. In other instances, the protective cover layer 440 is frosted or translucent to diffuse and/or mix the light 425,435 as it passes therethrough to result in diffused red/blue output light 450. In some instances, the protective cover layer 440 can be made of a frosted acrylic or poly(methylmethacrylate) (PMMA) (for example, a Lucite® material available from Perspex Distributors Limited, Blackburn, UK) with slight diffusing properties (i.e., having a diffusion angle between 10×10° and 50×50°). In some instances, suitable materials for the protective cover layer 440 include, but are not restricted to, a polycarbonate, a polyethylene terephthalate (PET), a glass, or a liquid silicone rubber. When the protective cover layer 440 is a diffusing protective cover layer, the diffusing properties of the diffusing protective cover layer are measured in terms of the light transmission (transparency) and light diffusion levels. The light transmission level is influenced by the material properties and the thickness of the diffusing cover. In some instances, the light transmission level is greater than about 80%. In some instances, the light transmission level is greater than about 85%. The diffusion of the diffusing protective cover may be enhanced by the incorporation of light diffusing additives into the material, inserting a thin diffusion film (not shown) between the emissive layer 430 and the protective cover layer 440, or by creating a surface diffusion by adding a texture to the surface of the diffusing protective cover layer. Light diffusing additives may include, but are not restricted to, mineral additives (for example, barium sulfate, zinc oxide, zinc sulfide, calcium carbonate or titanium dioxide) or cross-linked polymer particles. In some instances, the protective cover layer 440 has a thickness ranging from about 0.5 millimeters (mm) to about 20 mm. In other instances, the protective cover layer 440 has a thickness ranging from about 1 mm to about 15 mm. In yet other instances, the protective cover layer 440 has a thickness ranging from about 2 mm to about 10 mm. When a thin diffusion film is placed between the emissive layer 430 and the protective cover layer 440, the thin diffusion film can have a thickness ranging between about 200 and about 1,000 micrometers (μm). The thin diffusion film can be made of a material such as, for example, a polycarbonate, an acrylic, or a poly methyl(meth)acrylate.

FIG. 5 is a schematic illustration of another horticulture lighting apparatus 500 in accordance with various aspects of the present disclosure. The horticulture lighting apparatus includes a housing 510, an LED board 520 comprising a plurality of blue light-emitting LEDs (not shown), an emissive layer 530 comprising a plurality of quantum dots (not shown) capable of absorbing blue light from the plurality of blue light-emitting LEDs and emitting light having a wavelength within one or both of the red and far-red regions of the electromagnetic spectrum, a brightness enhancing film (BEF) 540, and a protective cover layer 550. In combination, the housing 510 and the protective cover layer 550 at least physically isolate the LED board 520, emissive layer 530 and BEF 540 from the environment external to the horticulture lighting apparatus 500. In some instances, the housing 510 and the protective cover layer 550 can combine to form a hermetic seal to further isolate the LED board 520, emissive layer 530 and BEF 540 from the environment external to the horticulture lighting apparatus 500. In some instances, the blue light-emitting LEDs are InGaN-based LEDs.

In some instances, the blue light-emitting LEDs emit blue light having a wavelength of about 450 nm. In some instances, the emissive layer 530 can have a thickness ranging from about 200 to about 600 μm. In other instances, the emissive layer 530 can have a thickness ranging from about 250 to about 550 μm, alternatively from about 300 to about 525 μm, alternatively from about 350 to about 500 μm, alternatively from about 400 to about 480 μm, and alternatively from about 430 to about 470 μm. In some instances, the emissive layer 530 can have about 0.8 to about 2 grams of quantum dots per square meter of film area. In other instances, the emissive layer 530 can have about 1 to about 1.75 grams of quantum dots per square meter of film area. In yet other instances, the emissive layer 530 can have about 1.2 to about 1.5 grams of quantum dots per square meter of film area.

In the horticulture lighting apparatus 500, blue light 525 is produced by the plurality of blue light-emitting LEDs of the LED board 520. The blue light 525 then travels to the emissive layer 530. In the emissive layer 530, a portion of the blue light 525 is absorbed by the plurality of quantum dots and converted to red and/or far-red light 535 while another portion of the blue light 525 is not absorbed by the plurality of quantum dots. The unabsorbed blue light 525 and the produced red/far-red light 535 then travels to the BEF 540. The BEF 540 increases the brightness of the unabsorbed blue light 525 and the red/far-red light 535 by making use of refracted and reflected light to recycle otherwise wasted light and direct more light toward a horticulture growth area. The brightness enhanced blue and red/far-red light then travels from the BEF 540 and through the protective cover layer 550 as output light 560.

In some instances, reflective or scattering agents are dispersed throughout the emissive layer 530 to assist in the scattering of light 525,535 within the film, promoting the production of a uniform spectral output, and/or increase the amount of light emitted from the emissive layer 530. In some instances, reflective or scattering agents can be made of, for example, polymer particles (for example, polytetrafluoro ethylene (PTFE) particles), metal particles (for example, silver or copper), metal oxide nanoparticles (for example, titanium dioxide or zinc oxide), aluminium silicate particles, yttrium aluminium garnet (YAG) particles, barium sulfate particles, and glass particles.

In some instances, the protective cover layer 550 is transparent such that blue light 525 emitted from the plurality of blue light-emitting LEDs and the red/far-red light 535 emitted from the plurality of quantum dots pass directly therethrough such that the optical path of the light 525,535 is substantially unchanged. In other instances, the protective cover layer 550 is frosted or translucent to diffuse and/or mix the light 525,535 as it passes therethrough to result in diffused red/blue output light 560. In some instances, the protective cover layer 550 can be made of a frosted acrylic or poly(methylmethacrylate) (PMMA) (for example, a Lucite® material available from Perspex Distributors Limited, Blackburn, UK) with slight diffusing properties (i.e., having a diffusion angle between 10×10° and 50×50°). In some instances, suitable materials for the protective cover layer 550 include, but are not restricted to, a polycarbonate, a polyethylene terephthalate (PET), a glass, or a liquid silicone rubber. When the protective cover layer 550 is a diffusing protective cover layer, the diffusing properties of a diffusing protective cover layer are measured in terms of the light transmission (transparency) and light diffusion levels. The light transmission level is influenced by the material properties and the thickness of the diffusing cover. In some instances, the light transmission level is greater than around 80%, for example greater than around 85%. The diffusion of the diffusing protective cover layer may be enhanced by the incorporation of light diffusing additives into the material, inserting a thin diffusion film (not shown) between the emissive layer 530 and the BEF 540 or between the BEF 540 and the protective cover layer 550, or by creating a surface diffusion by adding a texture to the surface of the diffusing protective cover layer. Light diffusing additives may include, but are not restricted to, mineral additives (for example, barium sulfate, zinc oxide, zinc sulfide, calcium carbonate or titanium dioxide) or cross-linked polymer particles. In some instances, the protective cover layer 550 has a thickness ranging from about 0.5 millimeters (mm) to about 20 mm. In other instances, the protective cover layer 550 has a thickness ranging from about 1 mm to about 15 mm. In yet other instances, the protective cover layer 550 has a thickness ranging from about 2 mm to about 10 mm. When a thin diffusion film is placed between the emissive layer 530 and the BEF 540 or between the BEF 540 and the protective cover layer 550, the thin diffusion film can have a thickness ranging between about 200 and about 1,000 micrometers (μm). The thin diffusion film can be made of a material such as, for example, a polycarbonate, an acrylic, or a poly methyl(meth)acrylate.

In some instances, the BEF 540 can utilize a prismatic structure to increase the brightness of the blue and red/far red light. In some instances, the prismatic structure of the BEF 540 can be defined as exhibiting a prismatic pitch (i.e., the distance between the peaks of adjacent prisms when the prism angle is fixed at 900) of 24 micrometers (μm). In some instances, the prismatic structure of the BEF 540 can be defined as exhibiting a prismatic pitch of 50 μm. In some instances, the prismatic structure can be defined as having prisms with sharp prism apexes. In some instances, the prismatic structure can be defined as having prisms with rounded prism apexes. In some instances, the prismatic structure can be defined as having prisms with flat or planar prism apexes. In some instances, the prismatic structure can be defined as having prisms which are all the same height relative to a common reference plane. In some instances, the prismatic structure can be defined as having prisms which exhibit randomly or logically varying heights relative to a common reference plane. In some instances, the BEF 540 can comprise two individual BEF sheets having prismatic structures and crossed at 900 to provide even further brightness enhancement.

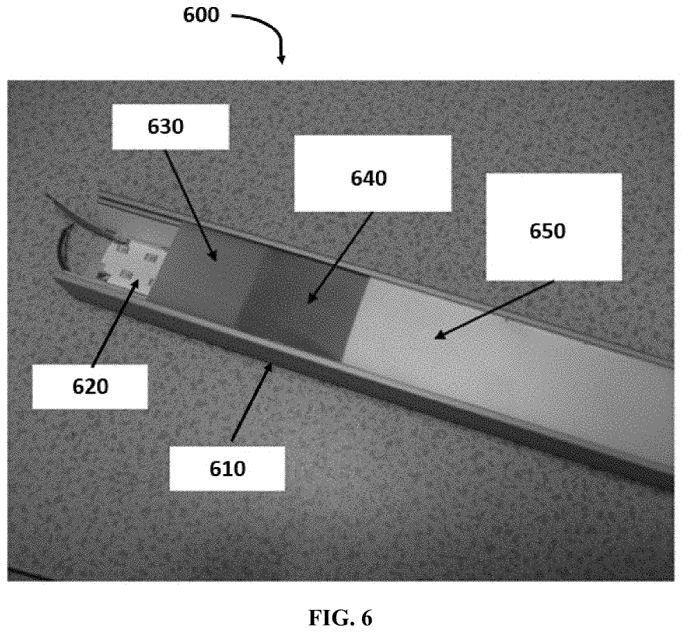

FIG. 6 is an image of a partially assembled horticulture lighting apparatus 600, in accordance with various aspects of the present disclosure. The horticulture lighting apparatus 600 exhibits a structure substantially according to horticulture lighting apparatus 500 schematically illustrated in FIG. 5, As can be seen, the partially assembled horticulture lighting apparatus 600 of includes a housing 610, an LED board 620, and QD-containing emissive layer 630, and brightness enhancing film (BEF) layer 640 and a protective cover layer 650 with light-diffusing properties.

In accordance with various aspects of the present disclosure, horticulture lighting apparatuses, such as horticulture lighting apparatus 400, horticulture lighting apparatus 500, and horticulture lighting apparatus 600 can be configured to emit one or more of blue light (i.e., light having a wavelength of 400-500 nm), green light (i.e., light having a wavelength of 500-600 nm), red light (i.e., light having a wavelength of 600-700 nm) and far red-light (i.e., light having a wavelength of 700-800 nm). Counterintuitively, the inventors of the instant application have found that horticulture lighting apparatuses which incorporate red light-emitting QDs and emit certain amounts of blue, red and far-red light result in superior plant quality, in terms of taste and texture, and faster plant growth as compared to commercially available horticulture lighting apparatuses which use LEDs rather than QDs for red light emission. Specifically, the inventors have found that horticulture lighting apparatuses using red light emitting QDs and emitting diffuse light having a red to blue photon ratio between about 2.35:1 and about 2.75:1, alternatively between about 2.4:1 and about 2.7:1, alternatively between 2.45:1 and about 2.65:1 and alternatively between about 2.4:1 and about 2.6:1, results in optimized plant quality in terms of taste and texture. At the same time, the inventors have found that horticulture lighting apparatuses using red light emitting QDs and emitting diffuse light having a red to far-red photon ratio from about 8.0:1 to about 11.0:1, alternatively from about 8.5:1 to about 10.5:1, alternatively from about 9:1 to about 10:1, alternatively from about 9.15:1 to about 9.85:1, alternatively from about 9.3:1 to about 9.7:1, and alternatively from about 9.4:1 to about 9.6:1, also beneficially improves plant quality in terms of taste and texture. Of the total amount of light emitted from a horticulture lighting apparatus according to the present disclosure, having wavelengths between 400-800 nm, the amount of said light having a wavelength in the far-red region can be from about 4.0% to about 7.5%, alternatively from about 4.5% to about 7%, alternatively from about 5% to about 7%, alternatively from about 5.5% to about 7%, alternatively from about 6% to about 7%, and alternatively from about 6.5% to about 7%.

QDs used in accordance with varying aspects of the present disclosure can have a size ranging from 2-100 nm. In some instances, the QDs can be core QDs. In some instances, the QDs can be core-shell QDs. In some instances, the QDs can be core multishell QDs. QDs used in accordance with various aspects of the present disclosure can be made of, or include a core material comprising:

IIA-VIA (2-16) material, consisting of a first element from group 2 of the periodic table and a second element from group 16 of the periodic table and also including ternary and quaternary materials and doped materials. Nanoparticle material includes but is not restricted to: MgS, MgSe, MgTe, CaS, CaSe, CaTe, SrS, SrSe, SrTe, BaS, BaSe, BaTe;

IIB-VIA (12-16) material consisting of a first element from group 12 of the periodic table and a second element from group 16 of the periodic table and also including ternary and quaternary materials and doped materials. Nanoparticle material includes but is not restricted to: ZnS, ZnSe, ZnTe, CdS, CdSe, CdTe, HgS, HgSe, HgTe;

II-V material, consisting of a first element from group 12 of the periodic table and a second element from group 15 of the periodic table and also including ternary and quaternary materials and doped materials. Nanoparticle material includes but is not restricted to: Zn₃P₂, Zn₃As₂, Cd₃P₂, Cd₃As₂, Cd₃N₂, Zn₃N₂;

III-V material, consisting of a first element from group 13 of the periodic table and a second element from group 15 of the periodic table and also including ternary and quaternary materials and doped materials. Nanoparticle material includes but is not restricted to: BP, AlP, AlAs, AlSb; GaN, GaP, GaAs, GaSb; InN, InP, InAs, InSb, AlN, BN;

III-IV material, consisting of a first element from group 13 of the periodic table and a second element from group 14 of the periodic table and also including ternary and quaternary materials and doped materials. Nanoparticle material includes but is not restricted to: B₄C, Al₄C₃, Ga₄C;

III-VI material, consisting of a first element from group 13 of the periodic table and a second element from group 16 of the periodic table and also including ternary and quaternary materials. Nanoparticle material includes but is not restricted to: Al₂S₃, Al₂Se₃, Al₂Te₃, Ga₂S₃, Ga₂Se₃, GeTe; In₂S₃, In₂Se₃, Ga₂Te₃, In₂Te₃, InTe;

IV-VI material, consisting of a first element from group 14 of the periodic table and a second element from group 16 of the periodic table, and also including ternary and quaternary materials and doped materials. Nanoparticle material includes but is not restricted to: PbS, PbSe, PbTe, SnS, SnSe, SnTe;

V-VI material, consisting of a first element from group 15 of the periodic table and a second element from group 16 of the periodic table, and also including ternary and quaternary materials and doped materials. Nanoparticle material includes but is not restricted to: Bi₂Te₃, Bi₂Se₃, Sb₂Se₃, Sb₂Te₃; and

Nanoparticle material, consisting of a first element from any group in the transition metal of the periodic table, and a second element from group 16 of the periodic table and also including ternary and quaternary materials and doped materials. Nanoparticle material includes but is not restricted to: NiS, CrS, CuInS₂, AgInS₂.

By the term doped nanoparticle for the purposes of specifications and claims, refers to nanoparticles of the above and a dopant comprised of one or more main group or rare earth elements, this most often is a transition metal or rare earth element, such as but not limited to zinc sulfide with manganese, such as ZnS nanoparticles doped with Mn²⁺.

The term “ternary material,” for the purposes of specifications and claims, refers to QDs of the above but a three-component material. The three components are usually compositions of elements from the as mentioned groups Example being (ZnₓCd₁₋ₓS)ₘLₙ nanocrystal (where L is a capping agent).

The term “quaternary material,” for the purposes of specifications and claims, refers to nanoparticles of the above but a four-component material. The four components are usually compositions of elements from the as mentioned groups Example being (ZnₓCd₁₋ₓS_{y}Se_{1-y})ₘLₙ nanocrystal (where L is a capping agent).

The material used on any shell or subsequent numbers of shells grown onto the core particle in most cases will be of a similar lattice type material to the core material i.e. have close lattice match to the core material so that it can be epitaxially grown on to the core, but is not necessarily restricted to materials of this compatibility. The material used on any shell or subsequent numbers of shells grown on to the core present in most cases will have a wider bandgap than the core material but is not necessarily restricted to materials of this compatibility. The materials of any shell or subsequent numbers of shells grown on to the core can include material comprising:

IIA-VIA (2-16) material, consisting of a first element from group 2 of the periodic table and a second element from group 16 of the periodic table and also including ternary and quaternary materials and doped materials. Nanoparticle material includes but is not restricted to: MgS, MgSe, MgTe, CaS, CaSe, CaTe, SrS, SrSe, SrTe;

IIB-VIA (12-16) material, consisting of a first element from group 12 of the periodic table and a second element from group 16 of the periodic table and also including ternary and quaternary materials and doped materials. Nanoparticle material includes but is not restricted to: ZnS, ZnSe, ZnTe, CdS, CdSe, CdTe, HgS, HgSe, HgTe;

II-V material, consisting of a first element from group 12 of the periodic table and a second element from group 15 of the periodic table and also including ternary and quaternary materials and doped materials. Nanoparticle material includes but is not restricted to: Zn₃P₂, Zn₃As₂, Cd₃P₂, Cd₃As₂, Cd₃N₂, Zn₃N₂;

III-V material, consisting of a first element from group 13 of the periodic table and a second element from group 15 of the periodic table and also including ternary and quaternary materials and doped materials. Nanoparticle material includes but is not restricted to: BP, AlP, AlAs, AlSb; GaN, GaP, GaAs, GaSb; InN, InP, InAs, InSb, AlN, BN;

III-IV material, consisting of a first element from group 13 of the periodic table and a second element from group 14 of the periodic table and also including ternary and quaternary materials and doped materials. Nanoparticle material includes but is not restricted to: B₄C, Al₄C₃, Ga₄C;

III-VI material, consisting of a first element from group 13 of the periodic table and a second element from group 16 of the periodic table and also including ternary and quaternary materials. Nanoparticle material includes but is not restricted to: Al₂S₃, Al₂Se₃, Al₂Te₃, Ga₂S₃, Ga₂Se₃, In₂S₃, In₂Se₃, Ga₂Te₃, In₂Te₃;

IV-VI material, consisting of a first element from group 14 of the periodic table and a second element from group 16 of the periodic table and also including ternary and quaternary materials and doped materials. Nanoparticle material includes but is not restricted to: PbS, PbSe, PbTe, SnS, SnSe, SnTe;

V-VI material, consisting of a first element from group 15 of the periodic table and a second element from group 16 of the periodic table, and also including ternary and quaternary materials and doped materials. Nanoparticle material includes but is not restricted to: Bi₂Te₃, Bi₂Se₃, Sb₂Se₃, Sb₂Te₃; and

Nanoparticle material, consisting of a first element from any group in the transition metal of the periodic table, and a second element from group 16 of the periodic table and also including ternary and quaternary materials and doped materials. Nanoparticle material includes but is not restricted to: NiS, CrS, CuInS₂, AgInS₂.

In some instances, QDs used in accordance with various aspects of the present disclosure can be made at least in part of perovskite materials of the form AMX₃, where A is an organic ammonium such as, but not restricted to, CH₃NH₃⁺, (C₈H₁₇)₂(CH₃NH₃)⁺, PhC₂H₄NH₃⁺, C₆H₁₁CH₂NH₃⁺ or 1-adamantyl methyl ammonium, an amidinium such as, but not restricted to, CH(NH₂)₂⁺, or an alkali metal cation such as, but not restricted to, Li⁺, Na⁺, K⁺, Rb⁺ or Cs⁺; M is a divalent metal cation such as, but not restricted to, Mg²⁺, Mn^{2+,} Ni²⁺, Co²⁺, Pb²⁺, Sn²⁺, Zn²⁺, Ge²⁺, Eu²⁺, Cu²⁺ or Cd²⁺; and X is a halide anion (F⁻, Cl⁻, Br⁻, I⁻) or a combination of halide anions.

In some instances, the QD-containing emissive layers 430,530 can be formed from two or more polymer materials, for example, two or more polymer resins. The films at least partially phase-separate, such that some domains within a film are primarily composed of a first polymer material or combination of first polymer materials (for example, a combination of two or more hydrophilic polymers) and other domains within the film are primarily a second polymer material or combination of second polymer materials (for example, a combination of two or more hydrophobic polymers). One of the polymer materials is chosen to be highly compatible with the QDs. Another of the polymer materials is highly effective at excluding oxygen. As a result, the multi-domain films can include QD-rich domains of QDs dispersed in a QD-compatible polymer material, those domains being surrounded by QD-poor domains of an oxygen-excluding polymer material. Thus, the QDs are suspended in a medium with which they are highly compatible and are protected from oxygen by the oxygen-excluding domains. The QD-containing emissive layers 430,530 can be described as multi-phase films utilizing at least a first phase (phase 1) resin that is compatible with the QD material and at least a second phase (phase 2) resin that is efficient at rejecting O₂.

Multi-phase QD-containing films can be prepared as follows. First, QDs are dispersed in a solution of the phase 1 resin (or resin monomer). The phase 1 resin is generally a hydrophobic resin, such as an acrylate resin. Examples of suitable phase 1 resins include, poly(methylmethacrylate), poly(ethylmethacrylate), poly(n-propylmethacrylate), poly(butyl (meth)acrylate), poly(n-pentyl (meth)acrylate), poly(n-hexyl (meth)acrylate), poly(cyclohexyl (meth)acrylate), poly(2-ethyl hexyl (meth)acrylate), poly(octyl (meth)acrylate), poly(isooctyl (meth)acrylate), poly(n-decyl (meth)acrylate), poly(isodecyl (meth)acrylate), poly(lauryl(meth)acrylate), poly(hexadecyl (meth)acrylate), poly(octadecyl (meth)acrylate), poly(isobornyl (meth)acrylate), poly(isobutylene), polystyrene, poly(divinyl benzene), polyvinyl acetate, polyisoprene, polycarbonate, polyacrylonitrile, hydrophobic cellulose based polymers like ethyl cellulose, silicone resins, poly(dimethyl siloxane), poly(vinyl ethers), polyesters or any hydrophobic host material such as wax, paraffin, vegetable oil, fatty acids and fatty acid esters.

Generally, the phase 1 resin can be any resin that is compatible with the QDs. The phase 1 resin may or may not be cross-linked or cross-linkable. The phase 1 resin may be a curable resin, for example, curable using UV light. In addition to the QDs and phase 1 resin (or resin monomer), the solution of the phase 1 resin may further include one or more of a photoinitiator, a cross-linking agent, a polymerization catalyst, a refractive index modifier (either inorganic one such as ZnS nanoparticles or organic one such as high refractive index monomers or poly(propylene sulfide)), a filler such as fumed silica, a scattering agent such as barium sulfate, a viscosity modifier, a surfactant or emulsifying agent, or the like.

The QD-phase 1 resin dispersion can then be mixed with a solution of the phase 2 resin (or resin monomer). As explained above, the phase 2 resin is a better oxygen barrier than the phase 1 resin. The phase 2 resin is generally a hydrophilic resin. The phase 2 resin may or may not be cross-linkable. The phase 2 resin may be a curable resin, for example, curable using UV light. Examples of phase 2 resins include epoxy-based resins, polyurethanes-based resins, hydrophilic (meth)acrylate polymers, polyvinyl alcohol, poly(ethylene-co-vinyl alcohol), polyvinyl dichloride, silicones, polyimides, polyesters, polyvinyls, polyamides, phenolics, cyanoacrylates, gelatin, water glass (sodium silicate), PVP (Kollidon). The solution of phase 2 resin may also include one or more of a photoinitiator, a cross-linking agent, a polymerization catalyst, a surfactant or emulsifying agent, or the like.

According to some embodiments, the phase 1-phase 2 mixture forms an emulsion, typically and emulsion of QD-containing phase 1 resin droplets (or isolated domains having similar or irregular shapes other than droplets) suspended in phase 2 resin. The composition of the emulsion can be adjusted by adjusting the relative concentrations of phase 1 and phase 2 resins, the rate of stirring of the mixture (i.e., rate of emulsification), the relative hydrophobicity of the phase 1 and phase 2 resins, and the like. One or more emulsifying agents, surfactants, or other compounds useful for supporting stable emulsions may be used.

In some instances, the QD-containing emissive layers 430,530 can be formed by creating a host matrix for the QDs whereby the QDs are maximally dispersed in a hydrophobic environment that is highly compatible with QD surfaces. One example of a suitable host matrix is isopropyl myristate (IPM). Hydrophobic compounds with structures similar to IPM can be used as host phases. Other examples include fatty acid esters and ethers, isopropyl myristate, isopropyl palmitate, phenyl palmitate, phenyl myristate, natural and synthetic oils, heat transfer liquids, fluorinated hydrocarbons, dibutyl sebacate, and diphenyl ether.

Host matrices such as IPM and the other hydrophobic materials mentioned above have the advantage that they are compatible with the hydrophobic surfaces of the QDs. Also, the matrices are not cured. Both of those properties minimize redshift. However, because they are not cured polymer matrices, such matrices tend to lack rigidity. To impart rigidity, and to de-aggregate (i.e., space apart) the QDs within the host matrix, a scaffolding or support material can be used to hold the dispersed nanoparticles in place. The scaffolding or support material can be any low polarity material with high surface area. The scaffolding material should be benign to both the QDs and solvent. Examples of suitable scaffolding or support materials are: fumed silica (Aerosils), fumed alumina, hydrophobic polymers (polyisoprene, cellulose esters, polyesters, polystyrene, porous polymer beads, and lipophilic sephadex.

QDs can be suspended in a hydrophobic host matrix, along with scaffolding or support material. The suspension can then be used to make a two-phase system by forming an emulsion of the host phase with an outer phase, which is typically a more hydrophilic and oxygen impermeable material, such as an epoxy resin. Examples of suitable outer phase materials include epoxy resins such EPO-TEK OG142, which is a commercially available single component, low viscosity epoxy. Other suitable outer phase materials include Sartomer CN104C80 (a bisphenol A based oligomer diluted with hydroxyethyl acrylate (HEA) with photoinitiators and inhibitors).

According to some embodiments, high glass transition temperature epoxy resins facilitate oxygen barrier as well as stable polymeric films at high temperature. The acrylates-based bisphenol A epoxy resins display fast curing rates. Hydroxy (meth)acrylates, such as 2-hydroxy ethyl acrylate (HEA), 2-hydroxy ethyl methacrylate (HEMA), hydroxy propyl acrylate (HPA), hydroxy propyl methacrylate (HPMA) or carboxylic acid (meth)acrylates such as 2-carboxy ethyl (meth)acrylate oligomer (CEAO or CEMAO), acrylic acid (AA), methacrylic acid (MMA) are used in the formulations to improve adhesion to gas barrier films and to adjust resin viscosity without affecting oxygen barrier property of bisphenol A-epoxy acrylates. It should be noted that polymer of HPA (T_{g}=22° C.), HPMA (T_{g}=76° C.) and HEMA (T_{g}=109° C.) show thermo-responsive behavior in aqueous solutions and become hydrophobic at temperature ≥40° C., indicating that the films are less sensitive to humidity. Polymers of (meth)acrylic acid, which show high glass transition temperature (T_{g} of PMAA=220° C.; T_{g} of PAA=70-106° C.) in some formulations with CN104 are also advantageous to ensure that the films are stable at high temperature.

### EXAMPLES

### Example 1

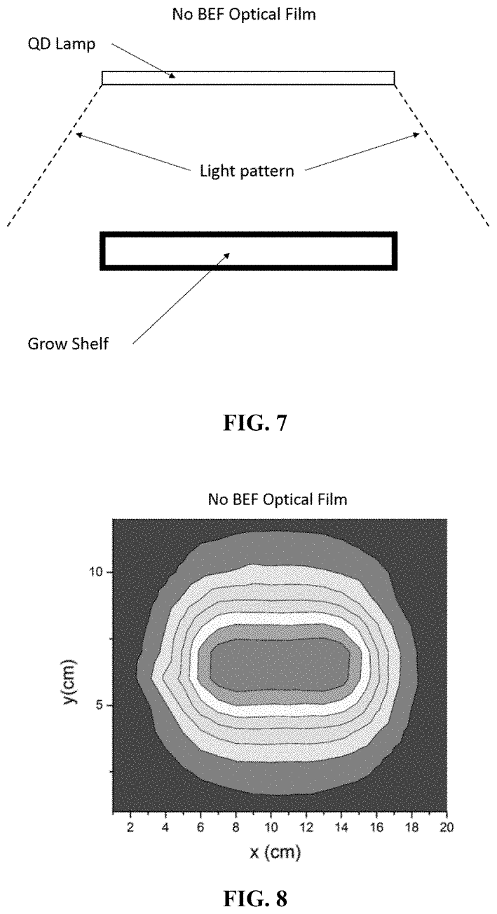

FIG. 7 is a schematic illustration showing the distribution of light onto a grow shelf from a quantum dot-containing horticulture lighting apparatus (“QD Lamp”) without a brightness enhancing optical film (BEF) in accordance with FIG. 4 of the present disclosure. FIG. 8 is a brightness enhancement map generated from the use of the QD Lamp without a BEF. The dimensions of the QD Lamp without a BEF was 500 mm×50 mm×25 mm.

The map shown in FIG. 8 was taken on a flat surface with the QD Lamp held 45 cm above said flat surface. Contours represent areas of similar PPFD coverage ranging from the highest in the centre and reducing as the light radiates out. In practice, at least a portion of the flat surface would constitute an illumination region where a plant would be located to be grown. As can be seen, a QD lamp without a BEF produces a very diffuse illumination pattern, particularly in the x-axis. The diffuse illumination pattern would lead to wasted light on a grow shelf as the length of the lamp is fitted to exact length of the shelf for installation. The sample with the BEF optical film however has a narrower illumination pattern in the x-axis resulting in higher light utilisation in the target illumination area.

### Example 2

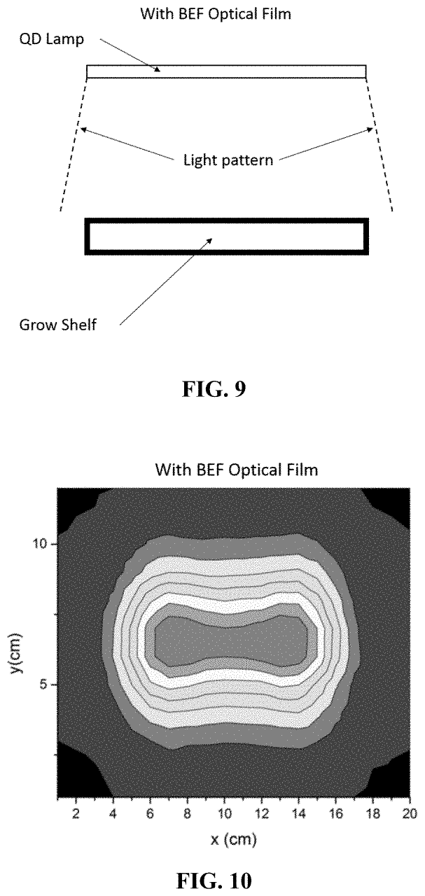

FIG. 9 is a schematic illustration showing the distribution of light onto a grow shelf from a quantum dot-containing horticulture lighting apparatus (“QD Lamp”) having a brightness enhancing optical film (BEF) in accordance with FIG. 5 of the present disclosure (“QD-BEF Lamp”). FIG. 10 is a brightness enhancement map generated from the use of the QD-BEF Lamp. The dimensions of the QD-BEF Lamp was 500 mm×50 mm×25 mm.

The map shown in FIG. 10 was taken on a flat surface with the QD-BEF Lamp held 45 cm above said flat surface. Contours represent areas of similar PPFD coverage ranging from the highest in the centre and reducing as the light radiates out. In practice, at least a portion of the flat surface would constitute an illumination region where a plant would be located to be grown. As can be seen, a QD-BEF Lamp produces a noticeably narrower illumination pattern as compared to the illuminating lamp of Example 1, resulting in higher light utilisation in the target illumination area.

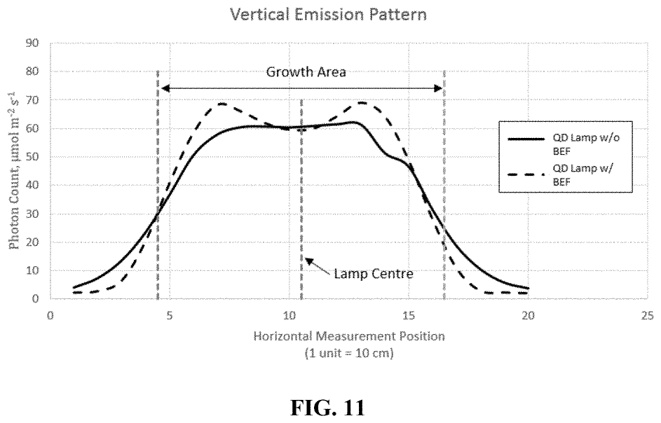

FIG. 11 is a graph comparing the vertical emission pattern (photon count relative to horizontal measurement position) of a quantum dot-containing horticulture lighting apparatus (“QD Lamp w/o BEF”) in accordance with FIG. 4 of the present disclosure and a quantum dot-containing lamp containing a BEF (“QD Lamp w/BEF”) in accordance with FIG. 5. As can be seen, a QD Lamp having a BEF film, in accordance with FIG. 5 of the present disclosure, provides more light to the underlying growth area than a QD Lamp in accordance with FIG. 4 without a BEF film. Specifically, the integrated area under the vertical emission pattern within the growth area is about 71.4 μmol·m⁻¹·s⁻¹ for the QD Lamp with a BEF while the same is only about 66.3 μmol·m⁻¹·s⁻¹ units for the QD Lamp without the BEF. As can also be seen, a QD-BEF Lamp exhibits lowered light emission (i.e., less wasted light) outside of the underlying growth area than a QD Lamp without a BEF film. Specifically, the integrated area under the vertical emission pattern outside of the growth area is only about 2.6 μmol·m⁻¹·s⁻¹ for the QD Lamp with a BEF while the same is about 6.2 μmol·m⁻¹·s⁻¹ for the QD Lamp without the BEF.

### Example 3

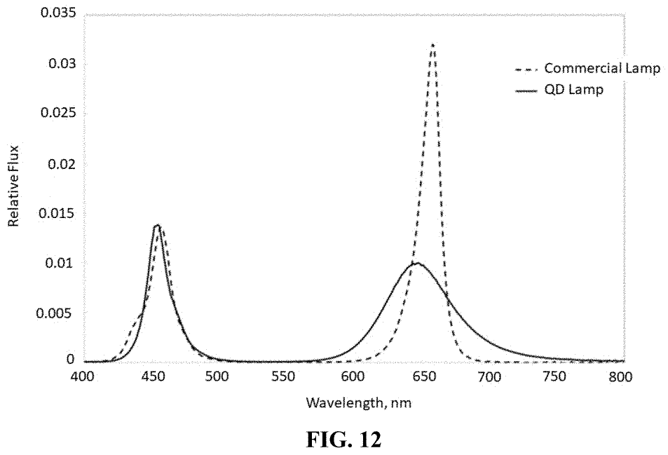

FIG. 12 is a graph comparing the spectral output of a commercially available horticulture lighting apparatus using red and blue light-emitting diodes (LEDs) and a quantum dot-containing horticulture lighting apparatus (“QD lamp”) in accordance with FIG. 4 and having a protective cover layer made of PMMA (Lucite®). The commercially available horticulture lighting apparatus was Philips GPLED production DR/B 150 LB LO, product code: 12NC 9290 009 10006, having a red to blue photon emitting ratio of 2.82 and no far-red light emission. The QD lamp used in accordance with various aspects of the present disclosure emitting blue, green, red, and far red light in amounts shown in Table 1.

TABLE 1

| | Relative Photon |
|---|---|
| | Count |
| Blue (400-500 nm) | 148.8 |
| Green (500-600 nm) | 14.4 |
| Red (600-700 nm) | 383.4 |
| Far-Red (700-800 nm) | 40.3 |
| Red:Blue Ratio | 2.58:1 |
| Red:Far-Red Ratio | 9.51:1 |

The QD-containing emissive layer of the QD lamp utilized QDs having a photoluminescence maximum (PLₘₐₓ) of 632 nm and a full-width at half-maximum (FWHM) of 56 nm. Table 2 provides comparative data for the commercially available horticulture lighting apparatus and the QD Lamp of the present disclosure.

TABLE 2

| | | | | Blue | Blue | Red | Red |
|---|---|---|---|---|---|---|---|
| | P_{In}, | P_{Out}, | μmol/s | Peak, | FWHM, | Peak, | FWHM, |
| | W | W | Out | nm | nm | nm | nm |
| Commercial | 15.3 | 6.25 | 30.66 | 457 | 19 | 659 | 17 |
| QD Lamp | 17 | 4.14 | 21 | 454 | 17 | 647 | 56 |

Surprisingly, even though the QD lamp had a lower total photon count, a lower PPFD (given in μmol/s) value and a broader red spectral component outside of the PAR range than the commercially available LED grow lamp (which had none), the QD grow lamp resulted in superior plant quality and markedly faster plant growth. Specifically, an edible cress was found to grow twice as fast over time using the QD grow lamp as compared to the commercially available horticulture lighting apparatus. Without being bound to any particular theory, it is believed that, the improved quality of the plants is thought to result from a combination of the broader full-width at half-maximum of the red QD film compared to that of red LEDs and the integration of a diffuser into the design of the apparatus. It is further hypothesized that the emission spectrum of the QD lamp provided herein, though theoretically sub-optimal for photosynthesis, may enhance the quality of plant growth by inducing stress within the plant due to the use of a far-red light component.

The particular emission spectrum of the QD Lamp of Example 3 was found to be beneficial for the production of edible cress. However, it is envisaged that this emission spectrum may also be beneficial for the growth of other plants, such as other salad plants. It is thought that the spectral output may be beneficial to several stages of plant development, rather than requiring different lamps, each with a different spectral output, at different stages during plant development. Further, using quantum dots, the PL peak position, FWHM, the red to blue ratio, and the red to far-red ratio may be tuned to emit a spectrum of light that provides benefits for other species of plant if a specific spectral output is required.

The horticultural lighting apparatuses described herein may provide a spectral output that is beneficial a multitude of plants. By combining a QD film with a diffuser and/or optical film(s), the lighting apparatuses of the present disclosure provide uniform, diffuse spectral outputs. The horticultural lighting apparatuses described herein may be incorporated into vertical farming system with controlled environmental conditions such as water, humidity, CO₂, temperature, nutrient concentration and nutrient pH.

Although the invention and its objects, features and advantages have been described in detail, other embodiments are encompassed by the invention. Finally, those skilled in the art should appreciate that they can readily use the disclosed conception and specific embodiments as a basis for designing or modifying other structures for carrying out the same purposes of the invention without departing from the scope of the invention.

What is claims is:

1. A horticultural lighting apparatus, the apparatus comprising:
a housing;
a blue-light emitting element disposed within the housing;
an emissive layer in optical communication with the blue-light emitting element, the emissive layer comprising:
a polymer material; and
a population of quantum dots dispersed within the polymer material, the population of quantum dots capable of absorbing blue light and emitting light having wavelengths in the red and far-red regions of the electromagnetic spectrum;
a brightness enhancing film in optical communication with the blue-light emitting element and the emissive layer; and
a protective cover layer,
wherein the protective cover layer and housing isolates the blue-light emitting element, the emissive layer and the brightness enhancing film from an environment external to the horticultural lighting apparatus.

2. The apparatus of claim 1, wherein the polymer material comprises a first polymer phase and a second polymer phase, the first polymer phase having the population of quantum dots dispersed therein.

3. The apparatus of claim 2, wherein the first polymer phase is in the form of a plurality of domains, the domains being surrounded by the second polymer phase.

4. The apparatus of claim 1, wherein the apparatus is configured to generate a light output having a red to blue photon ratio between about 2.35:1 and 2.75:1.

5. The apparatus of claim 4, wherein the apparatus is configured to generate a light output having a red to far-red photon ratio between about from about 8.0:1 to about 11.0:1.

6. The apparatus of claim 1, wherein the apparatus is configured to generate a light output having a red to far-red photon ratio between about from about 8.0:1 to about 11.0:1.

7. The apparatus of claim 1, wherein the apparatus is configured to generate a light output having wavelengths between 400 and 800 nm with about 4.0% to about 7.5% of the total light output in the far-red region of the electromagnetic spectrum.

8. The apparatus of claim 1, wherein the protective cover layer is frosted or translucent.

9. The apparatus of claim 1, wherein the emissive layer further comprises reflective or scattering agents.

10. A horticultural lighting apparatus, the apparatus comprising:
a housing;
a blue-light emitting element disposed within the housing;
an emissive layer in optical communication with the blue-light emitting element, the emissive layer comprising:
a polymer material; and
a population of quantum dots dispersed within the polymer material, the population of quantum dots capable of absorbing blue light and emitting light having wavelengths in the red and far-red regions of the electromagnetic spectrum;
and
a protective cover layer,
wherein the protective cover layer and housing isolates the blue-light emitting element and the emissive layer from an environment external to the horticultural lighting apparatus.

11. The apparatus of claim 10, further comprising a brightness enhancing film in optical communication with the blue-light emitting element and the emissive layer, wherein the protective cover layer and housing isolates the blue-light emitting element, the emissive layer and the brightness enhancing film from an environment external to the horticultural lighting apparatus.

12. The apparatus of claim 10, wherein the polymer material comprises a first polymer phase and a second polymer phase, the first polymer phase having the population of quantum dots dispersed therein.

13. The apparatus of claim 12, wherein the first polymer phase is in the form of a plurality of domains, the domains being surrounded by the second polymer phase.

14. The apparatus of claim 10, wherein the apparatus is configured to generate a light output having a red to blue photon ratio between about 2.35:1 and 2.75:1.

15. The apparatus of claim 14, wherein the apparatus is configured to generate a light output having a red to far-red photon ratio between about from about 8.0:1 to about 11.0:1.

16. The apparatus of claim 10, wherein the apparatus is configured to generate a light output having a red to far-red photon ratio between about from about 8.0:1 to about 11.0:1.

17. The apparatus of claim 10, wherein the apparatus is configured to generate a light output having wavelengths between 400 and 800 nm with about 4.0% to about 7.5% of the total light output in the far-red region of the electromagnetic spectrum.

18. The apparatus of claim 10, wherein the protective cover layer is frosted or translucent.

19. A method of growing a plant, the method comprising illuminating a plant with a horticultural lighting apparatus according to claim 1.

20. A method of growing a plant, the method comprising illuminating a plant with a horticultural lighting apparatus according to claim 10.
